(19) United States
(12) Patent Application Publication
(10) Pub. No.: US 2025/0370474 A1
(43) Pub. Date: Dec. 4, 2025

(54) METHOD AND SYSTEM FOR ASCERTAINING A SURFACE CONDITION OF A ROAD REGION

(71) Applicant: Robert Bosch GmbH, Stuttgart (DE)

(72) Inventors: Andreas Heyl, Weil Der Stadt (DE); Holger Niemann, Ludwigsburg (DE); Marcel Mausser, Asperg (DE); Nicolas Sommer, Remseck (DE)

(21) Appl. No.: 19/191,109

(22) Filed: Apr. 28, 2025

(30) Foreign Application Priority Data
May 29, 2024 (DE) 10 2024 204 988.3

(51) Int. Cl. G05D 1/646; G05D 1/248; G05D 105/45; G05D 107/13; G05D 109/10; G05D 111/10; G05D 111/20; G05D 111/50

(52) U.S. Cl. CPC G05D 1/646; G05D 1/248; G05D 2105/47; G05D 2107/13; G05D 2109/10; G05D 2111/17; G05D 2111/20; G05D 2111/52

(57) ABSTRACT

A method and a system for ascertaining a surface condition of a road region using at least one sensor of a vehicle. Data from the sensor are collected, wherein the collected data are evaluated in order to ascertain the surface condition of the road region. The surface condition is analyzed with regard to its shape, and at least one road defect of the road portion is ascertained. A planned vehicle trajectory of the vehicle is adjusted based on the at least one ascertained road defect in order to reduce the ascertained road defect and/or to prevent further road defects.

### CROSS REFERENCE

The present application claims the benefit under 35 U.S.C. § 119 of German Patent Application No. DE 10 2024 204 988.3 filed on May 29, 2024, which is expressly incorporated herein by reference in its entirety.

### BACKGROUND INFORMATION

Multiple methods for ascertaining the surface condition of roads are described in the related art.

German Patent Application No. DE 10 2020 214 833 A1 describes a method for providing a signal for controlling an at least partially automated vehicle, comprising the following steps: receiving environmental data; checking which regions of the lane currently driven on by the vehicle can be driven on without disturbing, hindering, and/or endangering other road users, on the basis of the environmental data; providing a signal for changing a lateral distance of the vehicle from a lateral lane boundary within the lane currently driven on by the vehicle, on the basis of the check.

German Patent Application No. DE 10 2017 223 634 A1 describes a method for generating digital road condition information, comprising the steps of: receiving sensor data on a sensor unit of a vehicle by an evaluation unit; wherein the sensor data comprise at least position data and movement data of the vehicle; classifying a vehicle movement by the evaluation unit, wherein the classification is performed by comparing the sensor data with sensor data profiles that are stored in the evaluation unit and to which road condition classes are assigned; generating an event data record by the evaluation unit if a match with a sensor data profile has been detected; wherein the event data record contains at least the associated road condition class, position data, and a timestamp; transmitting the event data record to a central computer having a central database; generating a road condition data record by the central computer; wherein the road condition data record is based on a plurality of event data records in the central database from different vehicles which have the same position data and defined timestamps.

Am object of the present invention is to provide a method and a system that provide an effective way to detect and possibly repair road defects.

### SUMMARY

The present invention relates to a method for ascertaining a surface condition of a road region by means of at least one sensor of a vehicle. According to an example embodiment, the data from the sensor are collected, the collected data are evaluated in order to ascertain the surface condition of the road region, the surface condition is analyzed with regard to its shape, and at least one road defect of the road portion is ascertained, wherein a planned vehicle trajectory of the vehicle is adjusted on the basis of the at least one ascertained road defect in order to reduce the ascertained road defect and/or to prevent further road defects.

The method according to the present invention provides for ascertaining the surface condition of road regions and adjusting the vehicle trajectory. This method uses data collected by at least one sensor of a vehicle not only to precisely determine the surface condition, but also to analyze the shape of the surface and to identify road defects resulting therefrom.

A technical advantage of this method of the present invention in comparison with the related art is that the sensor data are analyzed and used to dynamically adjust the vehicle trajectory. While conventional systems are usually limited to collecting data and possibly reporting it retrospectively or making simple adjustments, this method allows immediate and automatic adjustment of the vehicle trajectory in real time. This minimizes the likelihood of further damage to the road surface by steering the vehicle in a targeted manner around or over identified defects, such as potholes or ruts. This not only reduces maintenance costs for road infrastructure, but also significantly increases safety for road users.

A further advantage of the method of the present invention is that the vehicle reacts to detected road defects in real time. By directly using sensor data to instantly adjust the vehicle trajectory, it becomes possible to steer vehicles more effectively around or over defects in order to protect both the vehicles and the road infrastructure.

A further advantage of the method of the present invention is decentralized and precise data processing; in contrast to systems that use centralized data processing and may suffer delays in response time, the present invention allows decentralized processing of the sensor data directly in the vehicle. This leads to more rapid decision-making processes and more precise adjustment of the vehicle trajectory on the basis of the current road conditions.

A further advantage of the method of the present invention is improved data usage and integration, wherein data from different sensors and vehicles are analyzed to allow a more comprehensive and accurate assessment of road conditions. This not only helps in identifying road defects but also in preventative maintenance by detecting potential defect regions at an early stage.

A further advantage of the method of the present invention is active damage minimization, wherein the vehicles are controlled in a targeted manner such that they help to restore or smooth the road surface. In the long term, this can increase the service life of road infrastructure and improve safety for all road users.

Advantageously, the sensor of the vehicle can be a video camera, a radar sensor, an ultrasonic sensor, a LIDAR sensor, a positioning sensor, a GPS sensor, an acceleration sensor and/or a speed sensor.

This allows flexible and comprehensive data collection of the surface condition of the road region, allowing different types of road defect to be identified and classified precisely. If the vehicle drives into a rut or pothole, this can be ascertained using the acceleration sensor as well as the video camera, the radar sensor, the LIDAR sensor and/or the ultrasonic sensor.

Advantageously, the surface condition of the road portion can be ascertained by a comparison between a target trajectory and an actual trajectory of the vehicle.

This can increase the accuracy of the adjustment of the planned vehicle trajectory to effectively reduce road wear and improve driving safety. The target trajectory of the vehicle can, for example, be derived from previous data of the road region, such as sensor data from other vehicles and/or from map data. The presence of a road defect within the road region in question causes the actual trajectory to deviate significantly from the target trajectory. The presence of a rut can, for example, mean that the vehicle sinks into the rut to a depth of, for example, 5 cm, and thus that the actual trajectory deviates from the target trajectory at least in terms of depth. If the vehicle drives into a rut, this can also result in lateral forces, which also cause a deviation of the actual trajectory from the target trajectory.

Advantageously, the ascertained road defect can be a rut, a pothole, uplift caused by roots under the road and/or subsoil displacement under the road.

As a result, the method of the present invention is particularly versatile and can be applied to a wide range of road defects that could negatively affect road safety.

Advantageously, the collected data from sensors of multiple vehicles can be evaluated to ascertain the road defects of the analyzed road regions, wherein a single road defect is ascertained by multiple sensors of multiple vehicles, and the accuracy of the ascertained measured values is thereby improved.

This allows highly precise detection and analysis of road defects, which contributes to preventive maintenance and rapid repair. The detection of the same road region by multiple vehicles allows subsequent statistical analysis, thus improving the ascertainment of the surface condition.

Advantageously, the ascertained road defects can be entered in a map of the analyzed roads, wherein this map showing the road defects is displayed to a user within the vehicle by means of a display device, and/or the planned vehicle trajectory of the vehicle can be displayed to the user by means of the display device within the vehicle, so that the user can steer the vehicle along the planned vehicle trajectory in order to minimize existing road defects and prevent further road defects.

This provides interactive driving assistance that actively supports the driver in avoiding and minimizing road defects.

Advantageously, according to an example embodiment of the present invention, the data about the ascertained road defects can be used to steer a user-controlled, autonomous and/or semi-autonomous vehicle along the planned vehicle trajectory so that the road defects are at least partially repaired.

Thus, the present invention not only contributes to minimizing damage to the road portion in question, but also to actively repairing damaged road portions through adjusted driving behavior. The autonomous and/or semi-autonomous vehicle is then steered along the planned vehicle trajectory in order to minimize or repair road defects. This effect is additionally reinforced when there is a plurality of vehicles that are steered accordingly.

Advantageously, according to an example embodiment of the present invention, the planned vehicle trajectory can be selected such that the ascertained road defect, such as a rut or a bump in the road, is at least partially reduced by driving on the road portions to the left and right of the road defect, such as the rut, and thereby leveling the surface condition of the road region in question as much as possible.

This provides an effective method of repairing the road defect, which extends the service life of the road infrastructure. By driving on the road portions to the left and right of the rut, the corresponding road region is gradually leveled, step by step, and the rut is thereby at least partially repaired.

Advantageously, according to an example embodiment of the present invention, by selecting a vehicle speed of the vehicle in question and/or a resonance frequency generated thereby, for example when driving over a bridge, and/or by a quasi-chaotic planned vehicle trajectory of the vehicle, it is possible to prevent further road defects from forming in the road regions that have not yet been damaged.

The planned vehicle trajectory and/or the speed of the vehicle can be adjusted accordingly such that the forces exerted by the vehicle on the bridge do not fall into the resonance frequency and thereby amplify the vibration of the bridge. This can prevent possible damage to the bridge. The selection of the quasi-chaotic planned vehicle trajectory can also lead to the prevention of further road defects.

Advantageously, according to an example embodiment of the present invention, the planned vehicle trajectory can be adjusted in real time on the basis of the current data from the sensor.

This allows an immediate response to suddenly occurring road defects, thereby increasing the effectiveness of the repair and/or prevention of road defects.

Advantageously, according to an example embodiment of the present invention, the evaluation of the sensor data from multiple vehicles of a vehicle fleet can comprise a statistical analysis that determines a probability of the road defect in question, such as a rut, within the analyzed road region.

This creates a sound decision-making basis for adjusting vehicle trajectories on the basis of aggregated and analyzed data from a plurality of data sources from different vehicles.

The present invention additionally relates to a system for ascertaining a surface condition of a road region by means of at least one sensor of a vehicle according to the method according to the present invention described above, wherein the vehicle is a vehicle driven by a user, an autonomous vehicle or a semi-autonomous vehicle, wherein the sensor is suitable for collecting the data of the road region, wherein an evaluation unit is suitable for evaluating the collected data in order to ascertain the surface condition of the road region, wherein an analysis unit is suitable for analyzing the surface condition with regard to its shape and for ascertaining at least one road defect of the road portion.

This provides an integrated system that can be implemented in various conventional vehicle types in order to allow effective road monitoring and maintenance.

### BRIEF DESCRIPTION OF THE DRAWINGS

The present invention is explained with reference to the figures.

FIG. 1 is a schematic representation to illustrate the method for ascertaining a surface condition of a road region, according to an example embodiment of the present invention.

FIG. 2 is a schematic representation of a sectional view of the road region, according to an example embodiment of the present invention.

### DETAILED DESCRIPTION OF EXAMPLE EMBODIMENTS

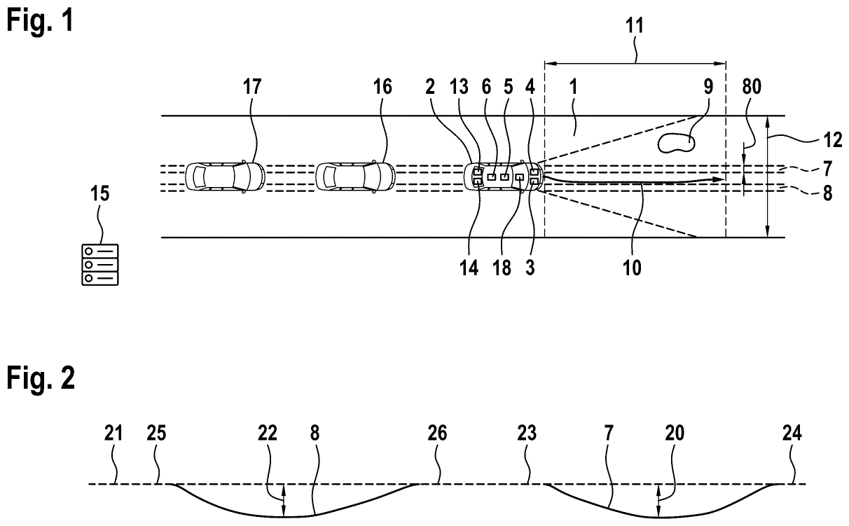

FIG. 1 shows a schematic representation to illustrate the method of the present invention for ascertaining a surface condition of a road region 1 by means of at least one sensor on a vehicle 2, such as a video camera 3, an ultrasonic sensor 4, a LIDAR sensor 5 and/or an acceleration sensor 6, wherein the data of the sensor 3-6 in question are evaluated in order to ascertain the surface condition of the road region 1. The surface condition of the road region 1 is analyzed with regard to its shape and to ascertain a road defect, such as a first rut 7, a second rut 8 or a pothole 9 on the roadway. On the basis of the ascertained road defects 7-9, a planned vehicle trajectory 10 of the vehicle 2 is then adjusted such that the ascertained road defects 7-9 are reduced and/or further defects are prevented. The road region 1 has a length 11 and a width 12. The size of the road region to be analyzed in front of the vehicle 2 depends on the range of the sensors 3-6 and thus on the extent of the data detected by the sensors 3-6. The collected data are evaluated by an evaluation unit 13 in order to ascertain the surface condition of the road region 1. Subsequently, by means of an analysis unit 14, the surface condition is analyzed with regard to its shape and at least one road defect 7-9 is ascertained. The measured data from the sensor 3-6 as well as the data about the ascertained road defects 7-9, such as position and dimensions, from the first vehicle 2 but also from further vehicles 16 and 17 can be transmitted to an external server 15, for example wirelessly, in order to collect the data of multiple vehicles 2, 16 and 17 and to evaluate said data accordingly. The information about the road defects 7-9 can be summarized in a map and displayed to a user by means of a display device 18 within the vehicle 2, 16 and 17. The vehicle 2 may also be an autonomous or a semi-autonomous vehicle, so that the vehicle 2 can be steered along the planned vehicle trajectory automatically. The first rut 7 and the second rut 8 can have a fixed width 19, for example of at least 80 cm.

FIG. 2 shows a schematic representation of a sectional view of the road region 1 containing the first rut 7 and the second rut 8. The first rut 7 has a first depth 20 of, for example, 5 cm below a plane 21 of the road region 1, wherein the second rut 8 has a second depth 22. The planned vehicle trajectory 10 from FIG. 1 is selected such that the two ruts 7 and 8 are reduced in their depth 20 and 22 by driving on a first road portion 23 to the left of the first rut 7, a second road portion 24 to the right of the first rut 7, a third road portion 25 to the left of the second rut 8 and/or a fourth road portion 26 to the right of the second rut 8, so that the surface condition of the road region 1 in question is thereby leveled as much as possible. A fleet of vehicles 2, 16 and 17 can be steered or guided by displaying the corresponding planned vehicle trajectory 10 such that the different road portions 23-26 are smoothed or leveled step by step one after the other.

What is claimed is:

1. A method for ascertaining a surface condition of a road region of a road using at least one sensor of a vehicle, the method comprising the following steps:
evaluating data collected by the sensor to ascertain the surface condition of the road region, wherein the surface condition is analyzed with regard to a shape of the surface condition;
ascertaining at least one road defect of the road region; and
adjusting a planned vehicle trajectory of the vehicle based on the at least one ascertained road defect to reduce the ascertained road defect and/or to prevent further road defects.

2. The method according to claim 1, wherein the sensor of the vehicle is a video camera and/or a radar sensor and/or an ultrasonic sensor and/or a LIDAR sensor and/or a positioning sensor and/or a GPS sensor and/or an acceleration sensor and/or a speed sensor.

3. The method according to claim 1, wherein the surface condition of the road region is ascertained by a comparison between a target trajectory and an actual trajectory of the vehicle.

4. The method according to claim 1, wherein the ascertained road defect is a rut and/or a pothole and/or an uplift caused by roots under the road and/or subsoil displacement under the road.

5. The method according to claim 1, wherein collected data from sensors of multiple vehicles are evaluated to ascertain road defects of analyzed road regions, wherein a single road defect is ascertained by multiple sensors of multiple of the vehicles, and an accuracy of ascertained measured values is improved.

6. The method according to claim 5, wherein the ascertained road defects are entered in a map of the analyzed road regions, wherein the map showing the road defects is displayed to a user within the vehicle using a display device, and/or the planned vehicle trajectory of the vehicle is displayed to the user by means of the display device within the vehicle, so that the user can steer the vehicle along the planned vehicle trajectory in order to minimize existing road defects and prevent further road defects.

7. The method according to claim 5, wherein data about the ascertained road defects are used to steer a user-controlled and/or autonomous and/or semi-autonomous vehicle along a planned vehicle trajectory so that the road defects are at least partially repaired.

8. The method according to claim 1, wherein the ascertained road defect is a rut, and the planned vehicle trajectory is selected such that the ascertained road defect is at least partially reduced by driving on road portions to the left and right of the rut and thereby leveling the surface condition of the road region as much as possible.

9. The method according to claim 8, wherein by selecting a vehicle speed of the vehicle and/or a resonance frequency generated thereby, further road defects are prevented from forming in the road regions that have not yet been damaged.

10. The method according to claim 1, wherein the planned vehicle trajectory is adjusted in real time based on current data from the sensor.

11. The method according to claim 5, wherein the evaluation of the sensor data from multiple vehicles of a vehicle fleet includes a statistical analysis that determines a probability of each road defect within the analyzed road region.

12. A system for ascertaining a surface condition of a road region using at least one sensor of a vehicle, wherein the vehicle is a vehicle driven by a user, the system comprising:
the vehicle, the vehicle being an autonomous vehicle or a semi-autonomous vehicle;
the sensor of the vehicle, the sensor being configured to for collect the data of the road region;
an evaluation unit configured to evaluate the collected data in order to ascertain the surface condition of the road region; and
an analysis unit configured analyze the surface condition with regard to a shape of the surface condition, and to ascertain at least one road defect of the road region;
wherein the system is configured to adjust a planned vehicle trajectory of the vehicle based on the at least one ascertained road defect to reduce the ascertained road defect and/or to prevent further road defects.
